(19) United States
(12) Patent Application Publication
(10) Pub. No.: US 2013/0339927 A1
(43) Pub. Date: Dec. 19, 2013

(54) Communications Platform Supporting Stateless Application Development

(71) Applicant: Digium, Inc., (US)

(72) Inventors: Kevin P. Fleming, Huntsville, AL (US); David M. Lee, II, Huntsville, AL (US)

(73) Assignee: DIGIUM, INC., Huntsville, AL (US)

(21) Appl. No.: 13/692,752

(22) Filed: Dec. 3, 2012

Related U.S. Application Data
(60) Provisional application No. 61/566,406, filed on Dec. 2, 2011.

(51) Int. Cl. G06F 9/44

(52) U.S. Cl. CPC G06F 8/70
USPC 717/120

(57) ABSTRACT

An apparatus for supporting development of software applications has been developed. The invention includes, multiple endpoints that interact with a user of a communications platform and a session manager (SM) that establishes and terminates a session with the endpoint. The invention has a session bridge (SB) that is a communication pathway between multiple endpoints and a session router (SR) that controls distribution of session request generated by the endpoint.

### CROSS-REFERENCE TO RELATED APPLICATIONS

This application claims priority from U.S. Provisional Patent Application No. 61/566,406 titled “Communications Platform Supporting Stateless Application Development” that was filed on Dec. 2, 2011.

### FIELD OF THE INVENTION

The invention relates generally to a system for a communications platform that supports stateless application development.

### BACKGROUND ART

Communications platforms designed to support session-oriented communications (e.g., audio sessions, telephone calls, audio/video sessions, video conferences) commonly include some of the following common elements used to implement their functionality:
Endpoints—Devices (or software) employed by users of the platform to interact with it;
Session Manager (“SM”)—This element is responsible for establishing, maintaining and terminating sessions to and from endpoints;
Session Router (“SR”)—This element is responsible for making decisions about how to handle incoming session requests generated by endpoints, and for making decisions about generating outgoing session requests to endpoints; and
Session Bridge (“SB”)—This element is responsible for interconnecting two (or more) sessions so that the users of the associated endpoints can communicate with each other.

The most basic example of this is depicted in Prior Art FIG. 1. Even though these elements are depicted as being separate entities in the figure (and in subsequent figures), in most communications platforms they may be actually ‘logical’ elements combined in a single component provided by the platform's manufacturer or provider. The interactions and connections between these elements are typically internal to the platform.

In order to provide high availability services for their users, communications platforms are frequently deployed with redundant elements. These redundant elements rely on a ‘state sharing’ mechanism that allows a standby element to become the active element and assume responsibility for session management, routing or bridging when necessary (e.g., detection of an element failure). A basic example of a prior art redundant communications platform is depicted in FIG. 2.

This platform shows the business application developer having to implement their own redundancy and high-availability mechanisms, in order to ensure that this parallel data storage provides the same level of service as the communications platform does itself For some platform/application combinations, this can be quite a significant burden, as the communications platform may be geographically dispersed and use complex load-sharing or load balancing mechanisms to provide its services, all of Which must be replicated by the business application developer.

### SUMMARY OF THE INVENTION

In some aspects, the invention relates to an apparatus for supporting development of software applications, comprising: multiple endpoints that interacts with a user of the platform; a session manager (SM) that establishes and terminates a session with the endpoint; a session router (SR) that controls distribution of session request generated by the endpoint; and a session bridge (SB) that is a communication pathway between multiple endpoints.

In other aspects, the invention relates to an apparatus for supporting development of software applications, comprising: means for establishing and terminating a session with an endpoint that interfaces with a user; means for controlling the distribution of a session request generated by the endpoint; and means for tracking the activities of the endpoint, SM and SR, and generating activity notifications to an exterior application located outside of the platform.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a diagram of a prior art telecommunications platform.

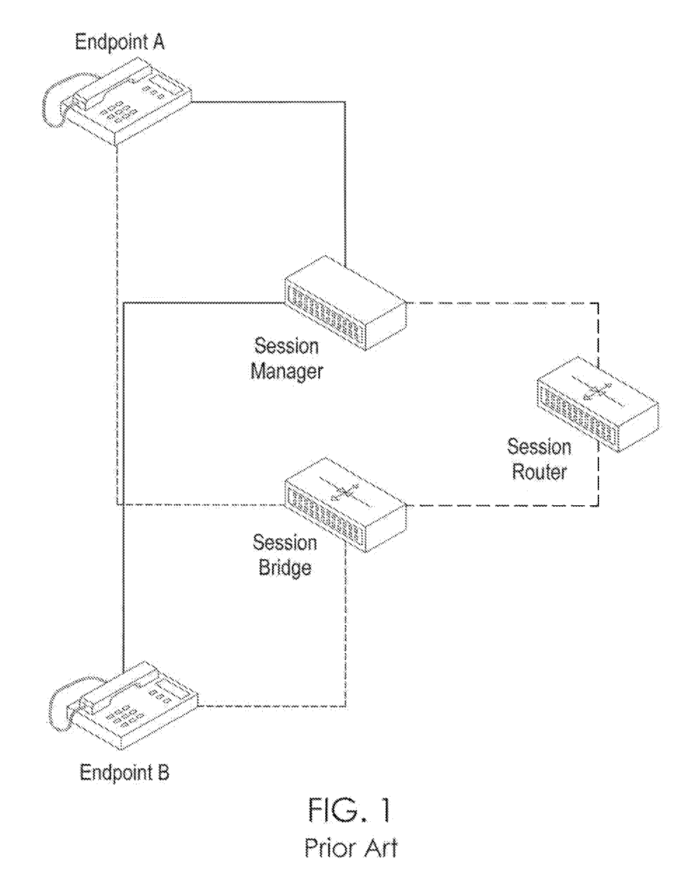

FIG. 2 shows a diagram of a prior art redundant communications platform in accordance with one embodiment of the present invention.

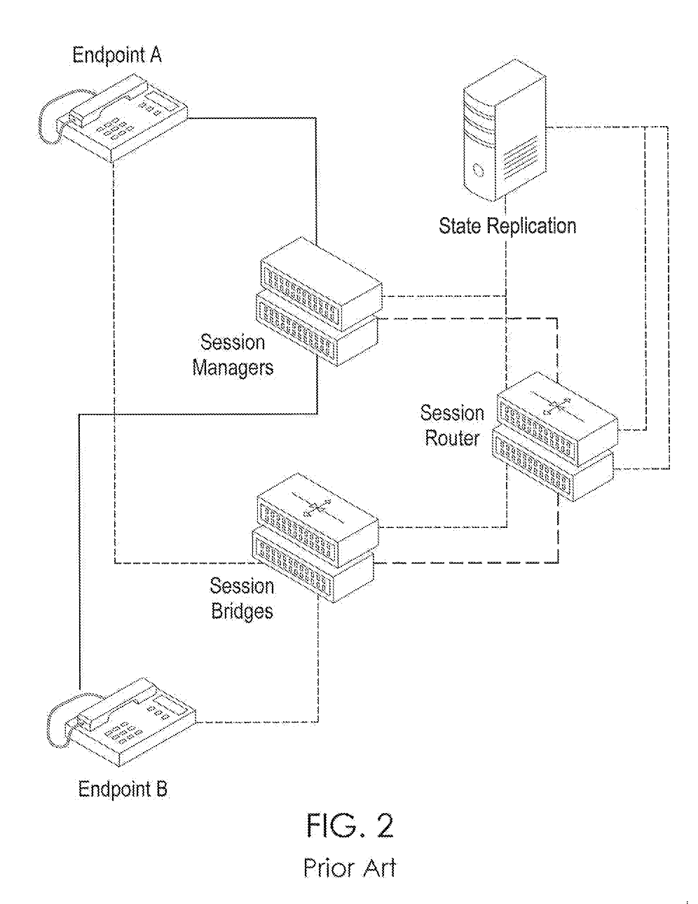

FIG. 3 shows a diagram of a communications platform providing an application gateway in accordance with one embodiment of the present invention.

FIG. 4 shows a diagram of a communications platform that supports two interactive applications in accordance with one embodiment of the present invention.

FIG. 5 shows a chart depicting the operation of one embodiment of the present invention.

FIG. 6 shows a chart depicting the operation of an alternative embodiment of the present invention.

### DETAILED DESCRIPTION

The present invention is a scalable communication framework (“SCF”) that provides a straightforward mechanism that related software application developers can employ to store their own data alongside other data from various other components. Data provided by the application is associated with a session, an endpoint, or some other object in the SCF system and that data is replicated to instances of the components providing that object's services. This means that the application developer does not need to provide their own mechanisms for persisting, replicating and associating that data. Instead, the developer can delegate all of the responsibility for those operations to the SCF system, and concentrate the development and implementation of their application.

The present invention relies on a mechanism known as “cookies”, which are similar in concept to the cookies that Web applications can send to Web browsers in order to store data in the user's local storage (and have it later returned to the application). In some embodiments, the cookies may be attached to telephony objects that allow applications to store application specific data tightly associated with telephony objects. These cookies take advantage of the replication, load sharing and failover features of the communications platform. The cookies are included in events and messages from the system, thus allowing applications to be written in a more stateless manner.

SCF applications can attach “hooks” to extension points, or subscribe to topics and be notified when a new object (session, bridge, etc.) is being created. The hook can then associate any amount of data necessary with that object. The SCF components will accept, store and return that data in an opaque fashion so that there is no need for the application developer to modify the components to understand how that data is formatted or how it is used.

Throughout the lifetime of the SCF object that the data has been associated with, each time the SCF component providing that object notifies any listener, controller or other application programming interface (“API”) defined service that has registered itself to interact with that object, the application data that has been associated with that object will be provided to the listening or controlling service as part of the notification. Through the use of this mechanism, an application interacting with the SCF system can be constructed in a nearly stateless fashion. Its services can be replicated across many instances, can use load-sharing mechanisms easily, and can seamlessly handle failover without the application developer having to deploy or utilize any systems or processes to do so.

In many business environments, there are multiple platforms used to support the business' processes. Common examples of these would include customer relationship management (CRM) and enterprise resource planning (ERP) systems. In order to achieve the most effective usage of these platforms, they are frequently “integrated”. The platform are connected to each other so that they can interact, share information and enable more efficient business processes. To enable this type of integration, most communications platforms provide an additional element:
Application Gateway (AG)—This element tracks the activities of the other elements (SM, SR and SB) in the communications platform and reports on these activities to one or more applications outside of the communications platform. In addition, it provides mechanisms that enable these applications to have some level of control over the activities of the SM, SR and SB.

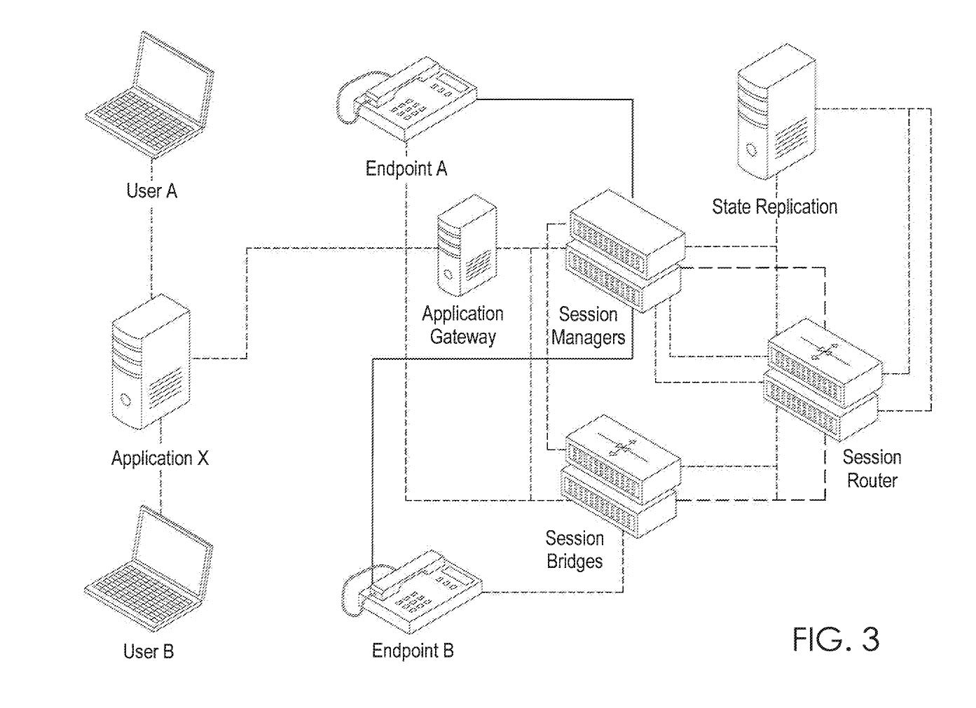

The AG will often implement a common ‘protocol’ for session management. Some examples of such protocols include: telephony application program interface (TAPI); computer supported telephony application (CSTA); voice extensible markup language (VoiceXML); and call control extensible markup language (CCXML). These protocols allow application designers and integrators to develop their application without concern for the communications platform that will be deployed, as long as it provides a suitable AG. In effect, the AG acts as a translator between the internal workings of the communications platform and the internal workings of the business application with which it has been integrated. An example of a communications platform providing an AG is depicted in FIG. 3.

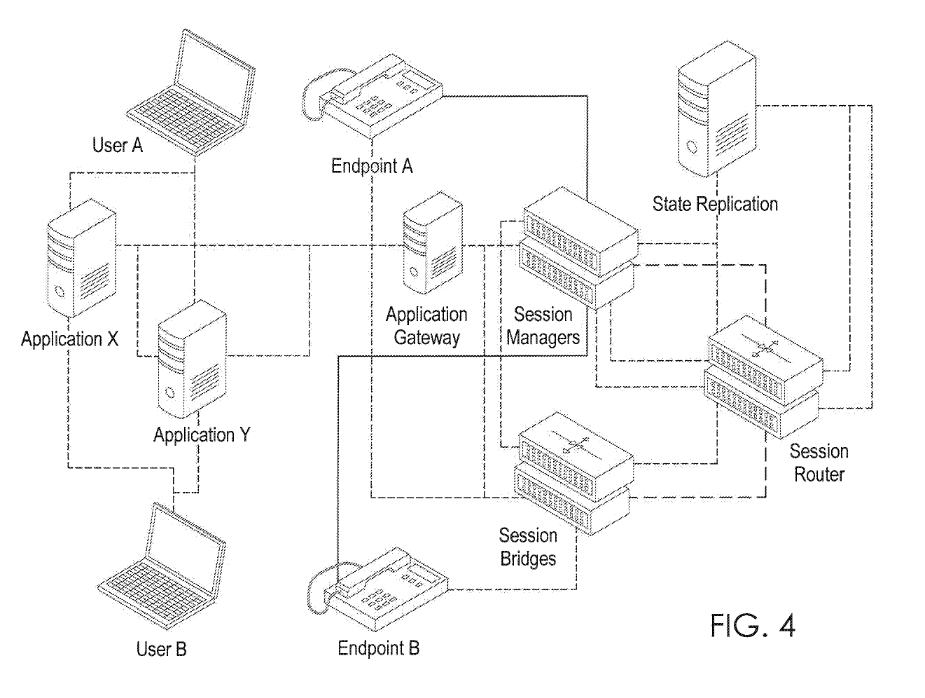

As previously mentioned, an AG can provide integration services to multiple business applications, acting independently of each other. Due to the nature of the application protocols usually implemented by these AGs, the business applications are isolated from each other. Effectively, the applications can only interact with the subset of the sessions being provided and managed by the communications platform belonging to each business application. Any interaction between the business applications must be performed directly between them. The AG is not involved in this interaction. An example of a communications platform supporting two business applications, which interact with each other, is depicted in FIG. 4.

These examples demonstrate some of the advantages derived by integrating business applications with a communications platform, but there are also concerns with these approaches. One of the most significant of these is the requirement for the business application to keep track of sessions that it is monitoring or managing. The AG will communicate the details of session state changes, but associating that session with data in the business application (e.g., customer or vendor records) is the responsibility of the business application, and it usually maintains the mapping between the session and the other data.

The present invention addresses this by allowing the business application developer to store this mapping information directly in the communications platform itself Any data that the business application derives, generates or otherwise associates with the sessions it monitors and manages is supplied to the SM. The data is stored and supplied back to the business application when needed by the SM. In addition, the business application can also associate data with the session bridges that it monitors and manages, by supplying this data to the SB. Again, the data is stored and supplied back to the business application when needed by the SB.

This allows the business application to directly benefit from the redundancy and high-availability mechanisms deployed in the communications platform, without replicating those mechanisms in a parallel system. If the communications platform is upgraded to provide a higher level of service to its users, the business application naturally gains that higher level of service as well. To accomplish this, the elements in the communications platform (the SM, SB and SR described above) provide the various following mechanisms.

Session Creation Notification—the SM can directly notify the business application as soon as a session is established (even before it is placed into active use), and will include in that notification any details the SM is aware of about the session's creator and the associated endpoint. The business application can then derive whatever data it needs from its own databases and services, and reply back to the SM with one or more structured data objects (SDO) to be stored with the session itself.

Session Listener Notification—if desired, the business application can subscribe to be notified of any state changes that occur during the session's lifetime; doing so makes the business application a ‘listener’ on that session. Each time the SM processes a change in the session's state, it will notify the business application of the new state and include in that notification any SDOs the application had previously stored with the session.

Session Bridge Creation Notification—the SB can directly notify the business application as soon as a session bridge is established (even before it is placed into active use), and will include in that notification any details the SB is aware of about the bridge's creator. If there are any session(s) being placed into the bridge upon its creation, the SB can also notify the business application of that list of session(s), and include in that notification any SDOs the application had previously stored with the session(s). the business application can also store SDOs directly on the session bridge itself, in a similar fashion to storing them on sessions.

Session Bridge Listener Notification—if desired, the business application can subscribe to be notified of any state changes that occur during the session bridge's lifetime; doing so makes the business application a ‘listener’ on that session bridge. Each time the SB processes a change in the session bridge's state, it will notify the business application of the new state and include in that notification any SDOs the application had previously stored with the session bridge. If the state change involves one or more session(s), the notification can also include any SDOs stored with those sessions.

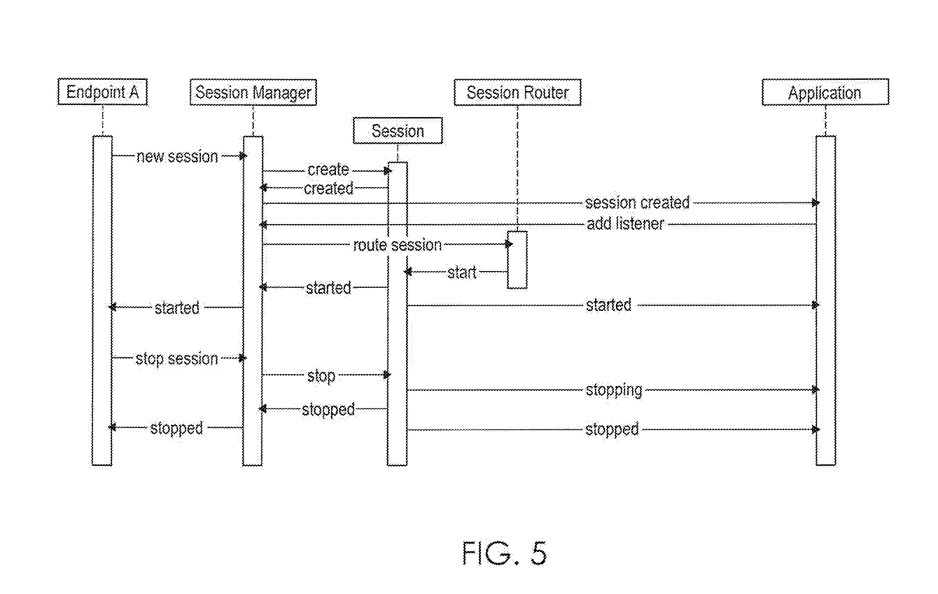

FIG. 5 shows an example of the operation of the simplest form of this solution, In this example, there is only a single endpoint (Endpoint A), an SM, an SR, and an application. The endpoint requests creation of a session, which the SR answers directly. The session is not bridged to another session.

In this example, the operation begins with Endpoint A requesting that a session be created by the SM. The SM then requests that the session be created and is notified when that is completed. The Application (having previously registered itself with the SM to he notified when new sessions are created) is notified by the SM that the session was created, and is given the opportunity to add itself as a listener on that session. The Application adds itself as a listener on the session, and includes one or more SDOs to be attached to the session. Next, the SM notifies the SR that the session needs to be routed. The SR performs session routing logic, and then notifies the session that it can be started and the session notifies the SM when it has been started. The SM then notifies Endpoint A that its session creation request was successful and the session has been started. The session notifies the application (previously added as a listener on the session) that the session has been started, and includes any SDOs the application previously attached to the session.

Once the operation's tasks are finished, Endpoint A requests that the session he stopped by the SM and the SM requests the session to stop. The session notifies the application (previously added as a listener on the session) that the session is stopping, and includes any SDOs the application previously attached to the session. The session notifies the SM that the session has stopped and the SM notifies Endpoint A that the session has stopped, The session notifies the Application (previously added as a listener on the session) that the session has been stopped, and includes any SDOs the Application previously attached to the session. This completes the session.

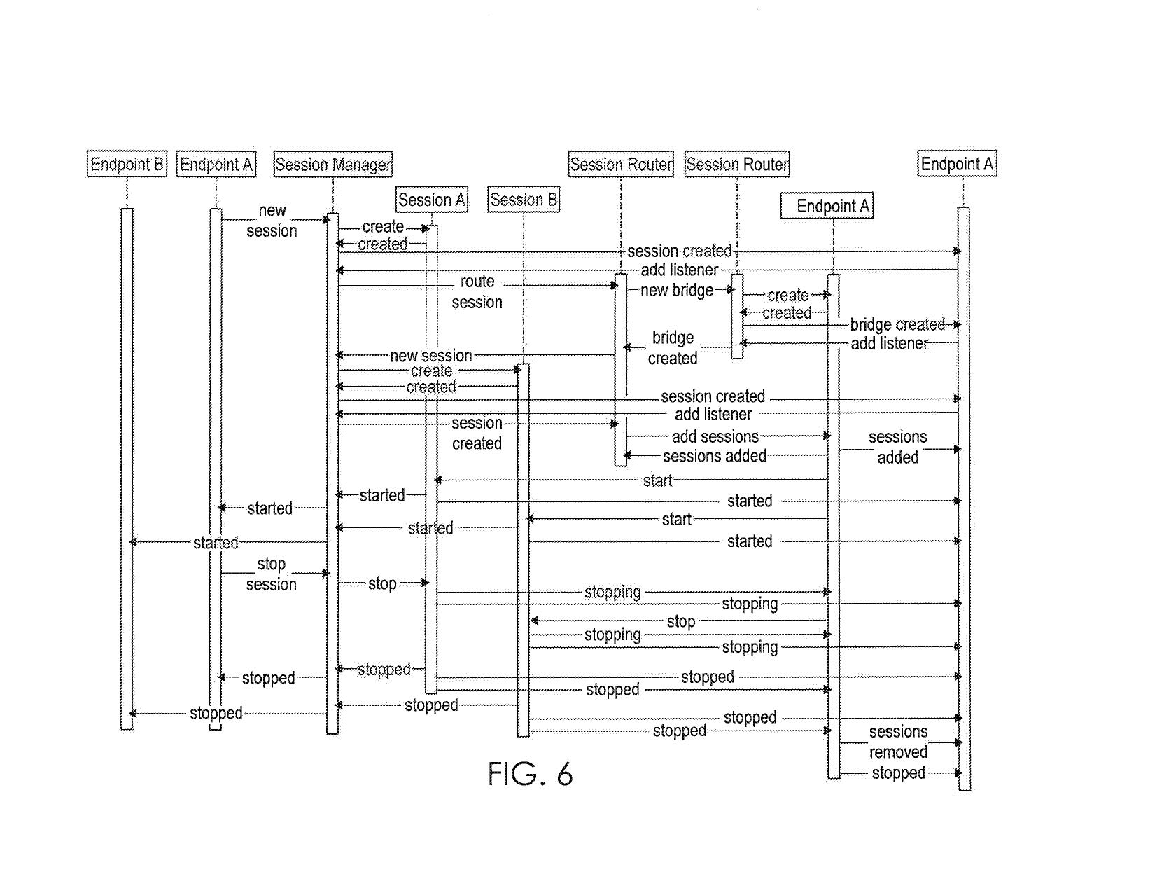

FIG. 6 shows the operation of a more complex form of this example. in this example, there are two endpoints (Endpoint A and Endpoint B), an SM, an SR, an SB and an Application. Endpoint A requests creation of a session, which the SR routes by creating a bridge, creating a session to Endpoint B, and bridging them together.

In this operation, Endpoint A initially requests that a session be created by the SM. The SM then requests that the session be created, and is notified when that is completed. The application (having previously registered itself with the SM to be notified when new sessions are created) is notified by the SM that session A was created, and is given the opportunity to add itself as a listener on that session. The application adds itself as a listener on session A, and includes one or more SDOs to he attached to the session. The SM notifies the SR that session A needs to be routed and the SR performs session routing logic, then requests that the SB create a bridge. The SB requests that the bridge be created, and is notified when that is completed. The application (having previously registered itself with the SB to be notified when new bridges are created) is notified by the SB that the bridge was created, and is given the opportunity to add itself as a listener on that bridge. The Application adds itself as a listener on the bridge, and includes one or more SDOs to be attached to the bridge. The SB then notifies the SR that the bridge has been created.

Next, the SR requests that the SM create a new session to Endpoint B. The SM requests that the session be created, and is notified when that is completed. The application (having previously registered itself with the SM to be notified when new sessions are created) is notified by the SM that session B was created, and is given the opportunity to add itself as a listener on that session. The Application adds itself as a listener on session B, and includes one or more SDOs to be attached to the session. The SM notifies the SR. that the session has been created and the SR requests that the sessions be added to the bridge. The bridge notifies the application (previously added as a listener on the bridge) that the sessions have been added, and includes any SDOs the application previously attached to the bridge and to the sessions being added to the bridge.

Next, the bridge notifies session A that it can be started. Session A notifies the

SM that it has been started. The SM notifies Endpoint A that its session creation request was successful and the session has been started. Session A notifies the application (previously added as a listener on the session) that the session has been started, and includes any SDOs the application previously attached to the session. The bridge then notifies session B that it can be started. Session B notifies the SM that it has been started. The SM notifies Endpoint B that the session has been started. Session B notifies the application (previously added as a listener on the session) that the session has been started, and includes any SDOs the application previously attached to the session.

Once the operation's tasks are finished, Endpoint A requests that the session be stopped by the SM and the SM requests the session to stop. Session A notifies the bridge (previously added as a listener on the session) that the session is stopping. Session A notifies the Application (previously added as a listener on the session) that the session is stopping, and includes any SDOs the Application previously attached to the session. The SB requests Session B to stop. Session B notifies the bridge (previously added as a listener on the session) that the session is stopping. Session B notifies the application (previously added as a listener on. the session) that the session is stopping, and includes any SDOs the application previously attached to the session. Next, Session A notifies the SM that the session has stopped. The SM notifies Endpoint A that the session has stopped. Session A notifies the bridge (previously added as a listener on the session) that the session has been stopped. Session A notifies the application (previously added as a listener on the session) that the session has been stopped, and includes any SDOs the application previously attached to the session. Session B notifies the SM that the session has stopped and the SM notifies Endpoint B that the session has stopped. Session B notifies the bridge (previously added as a listener on the session) that the session has been stopped. Session B notifies the application (previously added as a listener on the session) that the session has been stopped, and includes any SDOs the Application previously attached to the session. The bridge notifies the application (previously added as a listener on the bridge) that the sessions have been removed, and includes any SDOs the application previously attached to the bridge and to the sessions being added to the bridge. Finally, the bridge notifies the application (previously added as a listener on the bridge) that the bridge has been stopped, and includes any SDOs the application previously attached to the bridge.

An additional feature of the present invention is the support for structured data objects (SDO). This support allows a business application developer to define their own data structures to represent and transport the mapping information they wish to associate with a session or bridge. Through the use of this mechanism, the SCF system can ensure that each business application interacting with the SCF objects is only exposed to the SDOs that it understands. If two business applications are monitoring or managing the same sessions or bridges, they can do so safely without concern that the SCF system will supply them SDOs with a structure that they don't support.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. An apparatus for supporting development of software applications, comprising:
a. multiple endpoints that interacts with a user of a communications platform;
b. a session manager (SM) that establishes and terminates a session with one endpoint;
c. a session router (SR) that controls distribution of session request generated by one endpoint; and
d. a session bridge (SB) that is a communication pathway between multiple endpoints.

2. The apparatus of claim 1, further comprising:
an application gateway (AG) that tracks the activities of the endpoint, SM and SR and generates activity notifications to an exterior application located outside of the platform.

3. The apparatus of claim 2, where the activity notifications comprise:
a. a session creation notification that is generated upon the creation of a session; and
b. a session listener notification that is generated upon any state changes that occur during the session.

4. The apparatus of claim 2, where the activity notifications comprise:
a. a session bridge creation notification that is generated upon the creation of a session bridge; and
b. a session bridge listener notification that is generated upon any state changes that occur during the session.

5. The apparatus of claim 2, where the exterior application generates a structured data object (SDO) in response to an activity notification, where the SDO is received by the SM

6. The apparatus of claim 5, where the SDO is stored with the session data.

7. The apparatus of claim 5, where the SDO comprises mapping information generated by the exterior application.

8. The apparatus of claim 5, where the SDOs are only transmitted in at format that is understood by the exterior application.

9. The apparatus of claim 1, where the activity notifications include cookies that store application specific data.

10. apparatus of claim 9 where the cookies are associated with telephony objects.

11. The apparatus of claim 9, where the cookies utilize the replication, load sharing and lid lover features of the communication platform.

12. An apparatus for supporting development of software applications, comprising:
a. means for establishing and terminating a session with al endpoint that interfaces with a User;
b. means for controlling the distribution of a session request generated b the endpoint; and
c. means for tracking the activities of the endpoint, SM and SR, and generating activity notifications to an exterior application located outside of the platform.
